(19) United States
(12) Patent Application Publication
(10) Pub. No.: US 2024/0211581 A1
(43) Pub. Date: Jun. 27, 2024

(54) CONTACTLESS DATA TRANSMISSION FOR MEMORY DEVICES

(71) Applicant: Micron Technology, Inc., Boise, ID (US)

(72) Inventors: Graziano LEONE, Caserta (IT); Felice COSENZA, Naples (IT); Domenico BALZANO, Torre Annunziata (IT)

(21) Appl. No.: 18/525,041

(22) Filed: Nov. 30, 2023

Related U.S. Application Data
(60) Provisional application No. 63/476,686, filed on Dec. 22, 2022.

(51) Int. Cl. G06F 21/44; G06K 7/10

(52) U.S. Cl. CPC G06F 21/44; G06K 7/10297; G06K 7/10366

(57) ABSTRACT

Some implementations described herein relate to a contactless memory device analysis system. In some implementations, a system includes a chip; a memory disposed on the chip; an antenna module disposed on the chip and connected to the memory, the antenna module including an antenna and a transmit circuitry; and a controller. In some implementations, the controller is configured to receive a request command requesting an analysis of a status of the memory; transmit an authentication command associated with verifying that the reader device is authorized to request the analysis; receive authorization information indicating that the reader device is authorized to request the analysis; analyze the memory to determine the status of the memory based at least in part on determining that the reader device is authorized to request the analysis; and transmit information identifying the status of the memory as a response to the request command.

### CROSS-REFERENCE TO RELATED APPLICATION

This Patent Application claims priority to U.S. Provisional Patent Application No. 63/476,686, filed on Dec. 22, 2022, and entitled “CONTACTLESS DATA TRANSMISSION FOR MEMORY DEVICES.” The disclosure of the prior Application is considered part of and is incorporated by reference into this Patent Application.

### TECHNICAL FIELD

The present disclosure generally relates to memory devices and, for example, to contactless data transmission for memory devices.

### BACKGROUND

A memory device may be installed on a client device to provide data storage for the client device. For example, a computing device may include a chip or board onto which the memory device is installed. One technique for installing such a memory device is soldering. Periodically, it may be desirable to access the memory device. In one scenario, to access the memory device and perform an analysis (e.g., a diagnostic) on the memory device, an analysis device is physically connected to the memory device and communicates with the memory device via the physical connection. In another scenario, the memory device is desoldered from the computing device and installed in a testing machine for analysis.

### BRIEF DESCRIPTION OF THE DRAWINGS

FIG. 1 is a diagram illustrating an example system capable of contactless data transmission for memory devices.

FIG. 2 is a diagram of example components included in a memory device.

FIGS. 3A-3C are diagrams illustrating an example of contactless data transfer for a memory device.

FIGS. 4-6 are flowcharts of example methods associated with contactless data transmission for memory devices.

### DETAILED DESCRIPTION

In a first example, to perform an analysis or diagnostics on a memory device, the memory device, installed on a client device, may be physically connected to an analysis device (e.g., by plugging the analysis device into a hardwired connection on the client device). In a second example, the memory device may be desoldered from the client device, removed from the client device, and installed in a testing machine that can perform analysis or diagnostics. In the first example, providing a port for a wired connection for diagnostics of memory device may add complexity to the client device. The port may result in an excess form factor and/or redesign of many different types of client devices on which the memory device can be installed. In the second example, desoldering the memory device and installing the memory device on in a testing machine may result in thermal stressing of the memory device. Additionally, or alternatively, desoldering the memory device and installing the memory device on the testing machine may result in charge loss, which may negatively impact an accuracy of an analysis performed on the memory device.

Some implementations described herein provide for contactless data transmission for memory devices. For example, a memory device may include an antenna module connected to a memory of the memory device and enabling the memory device to wirelessly communicate with a reader device. The memory device and the reader device may perform a handshake procedure to authenticate the reader device for access to the memory device and, based on authentication, the memory device may provide information associated with the memory for analysis by the reader device or an analysis device connected to the reader device (e.g., a cloud-based analysis device). As a result, the memory device avoids excess complexity that results from using a physical connection, and/or thermal stressing and charge loss that results from desoldering the memory device. In this case, by using an authentication procedure linked to a hardware chain of trust (CoT) of the memory device, the memory device provides data security for a client device in which the memory device is installed, thereby improving data security relative to other techniques for wireless communication.

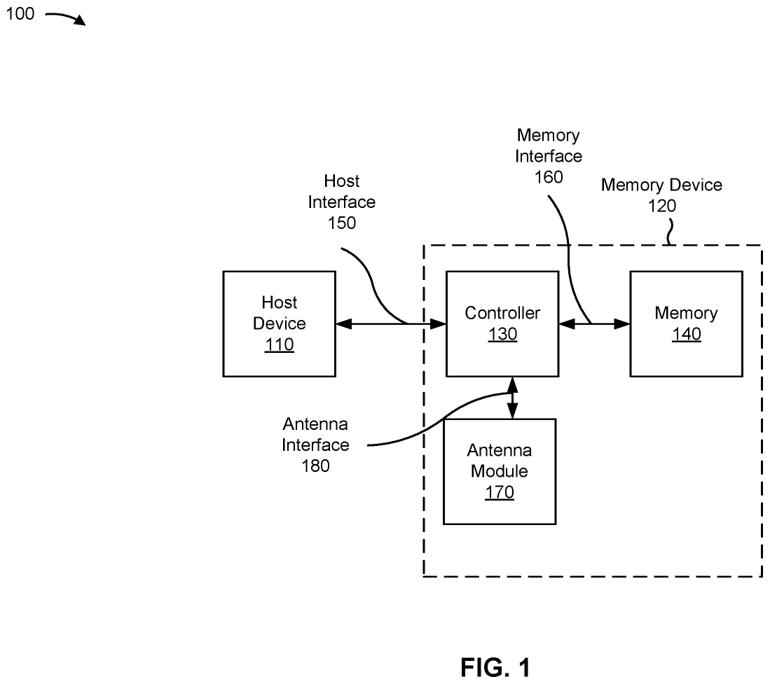

FIG. 1 is a diagram illustrating an example system 100 capable of contactless data transmission for memory devices. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160. The memory device 120 may include an antenna module 170. For example, the memory device 120 may include the memory 140, the antenna module 170, or the controller 130, among other examples, disposed on the same chip or substrate. The controller 130 and the antenna module 170 may communicate via an antenna interface 180. The antenna module 170 may include an antenna and transceiver circuitry (e.g., transmit circuitry and/or reception circuitry) to enable wireless communication.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a central processing unit (CPU), a graphics processing unit (GPU), a field-programmable gate array (FPGA), an application-specific integrated circuit (ASIC), and/or another type of processing component.

The memory device 120 may be any electronic device or apparatus configured to store data in memory. In some implementations, the memory device 120 may be an electronic device configured to store data persistently in non-volatile memory. For example, the memory device 120 may be a hard drive, a solid-state drive (SSD), a flash memory device (e.g., a NAND flash memory device or a NOR flash memory device), a universal serial bus (USB) thumb drive, a memory card (e.g., a secure digital (SD) card), a secondary storage device, a non-volatile memory express (NVMe) device, and/or an embedded multimedia card (eMMC) device. In this case, the memory 140 may include non-volatile memory configured to maintain stored data after the memory device 120 is powered off. For example, the memory 140 may include NAND memory or NOR memory. In some implementations, the memory 140 may include volatile memory that requires power to maintain stored data and that loses stored data after the memory device 120 is powered off, such as one or more latches and/or random-access memory (RAM), such as dynamic RAM (DRAM) and/or static RAM (SRAM). For example, the volatile memory may cache data read from or to be written to non-volatile memory, and/or may cache instructions to be executed by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be an SSD controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, and/or an embedded multimedia card (eMMC) interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, the memory device 120 and/or the controller 130 may be disposed on the chip; the antenna module 170 may also be disposed on the chip; and the memory device 120 and/or the controller 130 may be configured to receive, via the antenna module 170 and from a reader device, a request command requesting an analysis of a status of the memory; transmit, via the antenna module 170, an authentication command associated with verifying that the reader device is authorized to request the analysis; receive, via the antenna module 170, authorization information indicating that the reader device is authorized to request the analysis; analyze the memory 140 to determine the status of the memory based at least in part on determining that the reader device is authorized to request the analysis; and transmit, via the antenna module 170 and to the reader device, information identifying the status of the memory 140 as a response to the request command.

In some implementations, the memory device 120 and/or the controller 130 may receive an identification signal from a reader device; transmit information identifying the memory device 120 as a response to the identification signal; pair, based on transmitting the information identifying the memory device 120, with the reader device using authentication information received from the reader device; receive a request command requesting an analysis of a status of the memory 140 based on pairing with the reader device; analyze the memory 140 to determine the status of the memory 140 based at least in part on receiving the request command; and transmit information identifying the status of the memory 140 as a response to the request command.

As indicated above, FIG. 1 is provided as an example. Other examples may differ from what is described with regard to FIG. 1.

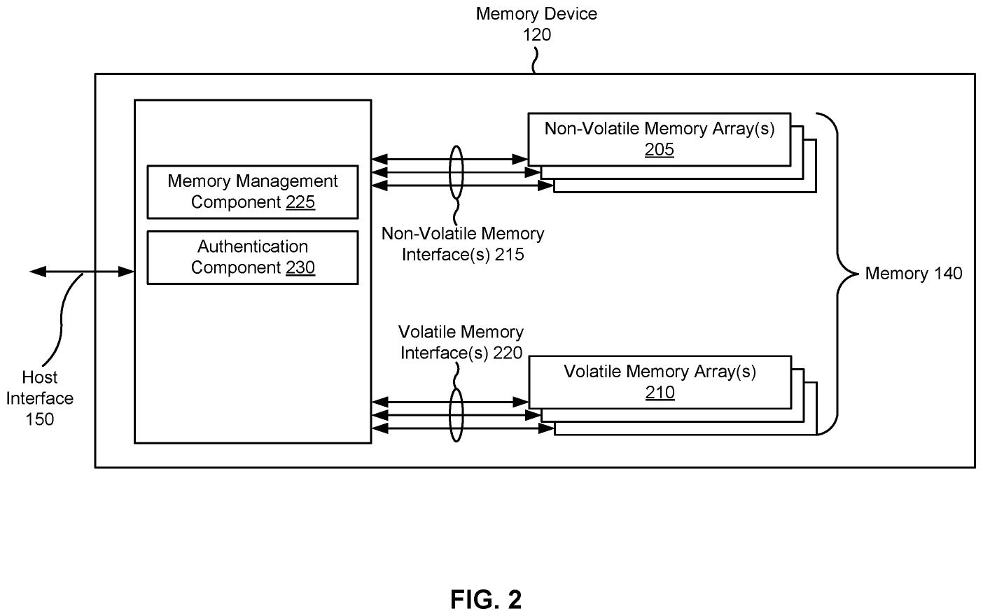

FIG. 2 is a diagram of example components included in a memory device 120. As described above in connection with FIG. 1, the memory device 120 may include a controller 130 and memory 140. As shown in FIG. 2, the memory 140 may include one or more non-volatile memory arrays 205, such as one or more NAND memory arrays and/or one or more NOR memory arrays. Additionally, or alternatively, the memory 140 may include one or more volatile memory arrays 210, such as one or more SRAM arrays and/or one or more DRAM arrays. The controller 130 may transmit signals to and receive signals from a non-volatile memory array 205 using a non-volatile memory interface 215. The controller 130 may transmit signals to and receive signals from a volatile memory array 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, sub-blocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory array). In some implementations, the controller 130 may translate a host interface command (e.g., a command received from the host device 110) into a memory interface command (e.g., a command for performing an operation on a memory array).

As shown in FIG. 2, the controller 130 may include a memory management component 225 and/or an authentication component 230. In some implementations, one or more of these components are implemented as one or more instructions (e.g., firmware) executed by the controller 130. Alternatively, one or more of these components may be implemented as dedicated integrated circuits distinct from the controller 130.

The memory management component 225 may be configured to manage performance of the memory device 120. For example, the memory management component 225 may perform wear leveling, bad block management, block retirement, read disturb management, and/or other memory management operations. In some implementations, the memory device 120 may store (e.g., in memory 140) one or more memory management tables. A memory management table may store information that may be used by or updated by the memory management component 225, such as information regarding memory block age, memory block erase count, and/or error information associated with a memory partition (e.g., a memory cell, a row of memory, a block of memory, or the like). The memory management component 225 may be configured to analyze and/or determine a status of the memory 140. For example, the memory management component 225 may identify a wear level, a set of bad blocks, a set of blocks for retirement, or a set of block errors, among other examples.

The authentication component 230 may be configured to authenticate a reader device for access to the memory 140. For example, the authentication component 230 may store one or more keys, certificates, or other credentials associated with the memory 140 and may receive one or more keys, certificates, or other credentials associated with the reader device. In this case, the authentication component 230 may use the one or more stored or received keys, certificates, or other credentials to determine whether the reader device is authorized to access the memory 140. In some implementations, the authentication component 230 may enforce a CoT based on a hardware root of trust (HRoT) or unique device secret (UDS) provided to the memory device 120 or to a reader device.

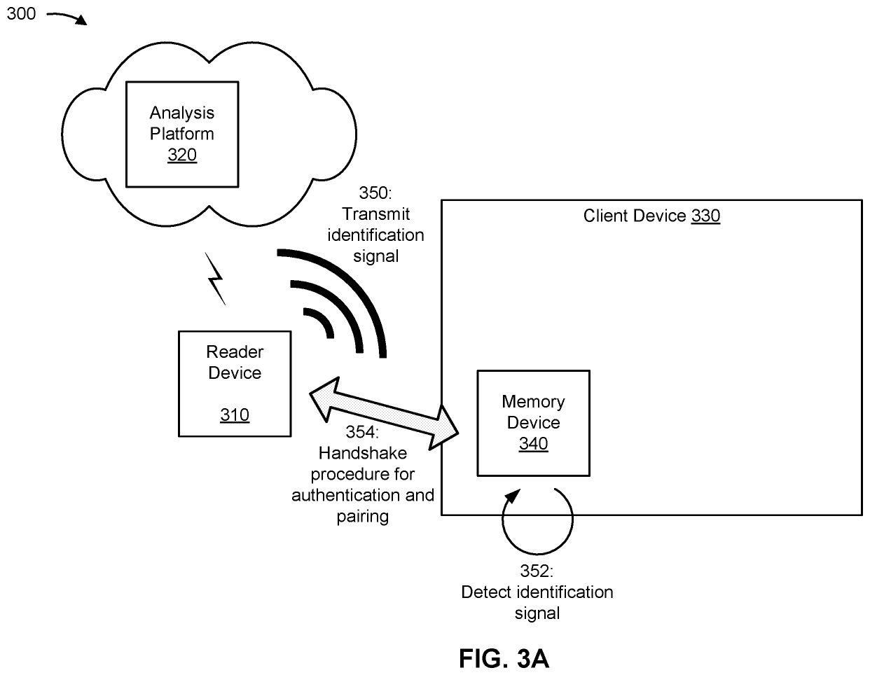

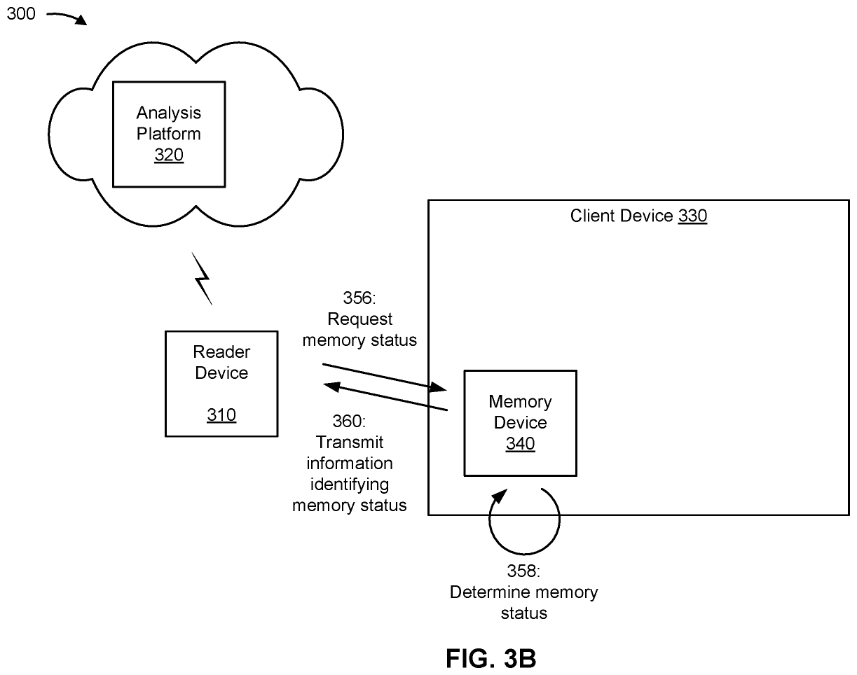

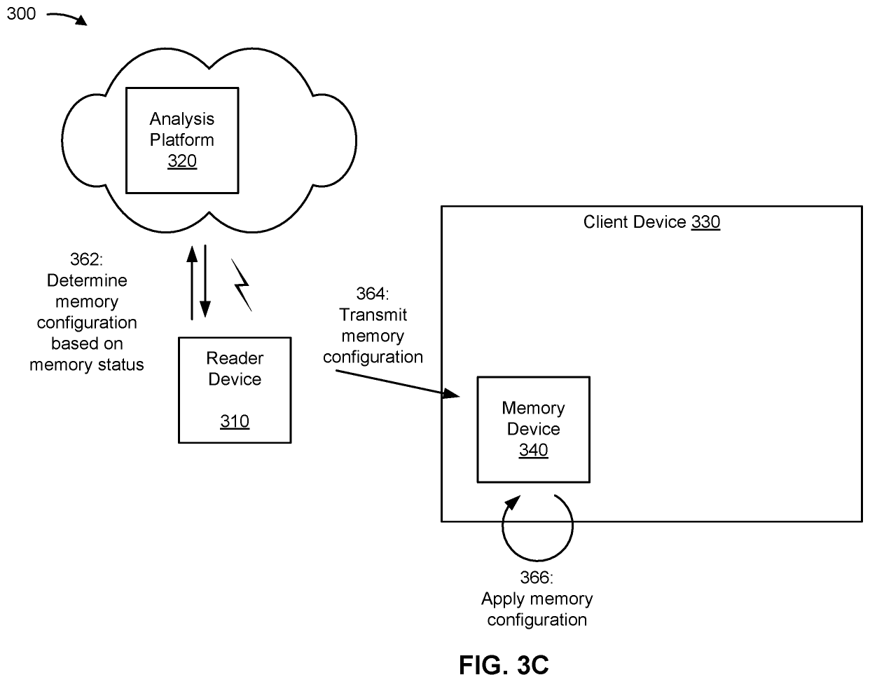

One or more devices or components shown in FIG. 2 may be configured to perform operations described herein, such as one or more operations and/or methods described in connection with FIGS. 3A-6. For example, the controller 130, the memory management component 225 and/or the authentication component 230 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

FIGS. 3A-3C are diagrams illustrating an example 300 of contactless data transfer for a memory device. As shown in FIGS. 3A-3C, example 300 includes a reader device 310, an analysis platform 320 (e.g., a cloud-based computing platform), a client device 330, and a memory device 340. The memory device 340 may correspond to the memory device 120 and be installed on a chip or board of the client device 330.

As shown in FIG. 3A, and by reference numbers 350 and 352, the reader device 310 may transmit an identification signal and the memory device 340 may detect the identification signal. For example, the reader device 310 may broadcast the identification signal to attempt to discover one or more memory devices 340 within a threshold proximity of the reader device 310. In this case, the memory device 340 may use an antenna module thereof to monitor for identification signals and may detect the identification signal broadcast by the reader device 310.

In some implementations, the memory device 340 may periodically attempt to detect an identification signal. For example, the memory device 340 may activate the antenna module for a first period of time to monitor for the identification signal and deactivate the antenna module for a second period of time to reduce power consumption associated with detecting the identification signal. In this case, the memory device 340 and the reader device 310 may be configured with respective monitoring periods and transmission periods, such that a monitoring period of the memory device 340 overlaps with a transmission period of the reader device 310.

In some implementations, the identification signal may activate the memory device 340 to communicate. For example, the reader device 310 may transmit a signal to a resonant inductive coupler of the antenna module of the memory device 340. In this case, the resonant inductive coupler, based on receiving the signal, may capture electromagnetic energy of the identification signal and use the electromagnetic energy to power the memory device 340 or to activate the memory device 340 (e.g., to obtain power from the client device 330). Based on the memory device 340 being activated, the memory device 340 may use a controller thereof to control the antenna module to communicate with the reader device 310. Additionally, or alternatively, the memory device 340 may include, in the antenna module, a chip that can be read by the reader device 310 when the reader device transmits the identification signal. In other words, the identification signal may be an attempt to read a chip of a nearby memory device 340. Based on reading the chip of the memory device 340 and/or writing to the chip of the memory device 340, the memory device 340 may be activated to communicate with the reader device 310.

In some implementations, the reader device 310 and the memory device 340 may communicate using a particular type of wireless communication. For example, the reader device 310 and the memory device 340 may communicate using radio frequency identification (RFID) wireless communication, contactless card reading wireless communication, near field communication (NFC), Bluetooth communication, Bluetooth low energy communication, Wi-Fi communication, or another wireless communication standard.

As further shown in FIG. 3A, and by reference number 354, the reader device 310 may perform a handshake procedure for authentication and pairing. For example, the reader device 310 may transmit authentication information to the memory device 340 and/or receive authentication information from the memory device 340. In some implementations, the reader device 310 may pair with the memory device 340 based on exchanging the authentication information. For example, the reader device 310 and/or the memory device 340 may store information enabling identification of commands and/or messages between the reader device 310 and the memory device 340 as genuine without further authentication being required.

In some implementations, the memory device 340 may receive one or more keys or certificates from the reader device 310. For example, the memory device 340 may receive a certificate signed with a key of the reader device 310 and may evaluate the certificate to determine whether the reader device 310 is authentic (e.g., is linked to the same chain of trust (CoT) as the memory device 340). In some implementations, the memory device 340 may use a unique device secret (UDS) or other aspect of a CoT to verify the reader device 310. For example, the memory device 340 may determine that the reader device 310 is authorized by the same manufacturer that manufactured the memory device 340 (e.g., based on determining that the reader device 310 and the memory device 340 have security information branching from a shared CoT). In this way, the memory device 340 avoids granting access to a malicious actor, by restricting access to the memory device 340 to reader devices 310 from an authorized source (e.g., the same manufacturer that manufactured the memory device 340).

In some implementations, the reader device 310 may leverage the client device 330 to verify the reader device 310. For example, the memory device 340 may request that the client device 330 communicate with an external source, such as the analysis platform 320. In this case, the client device 330 may establish a connection (e.g., via the Internet) to the analysis platform 320 and the reader device 310 ay also establish a connection to the analysis platform 320. The analysis platform 320 may analyze credentials from the reader device 310 and the memory device 340 (e.g., via the client device 330) and provide one or more commands (e.g., to the reader device 310 and/or the memory device 340) indicating whether the credentials indicate that the reader device 310 is authorized to access the memory device 340.

As shown in FIG. 3B, and by reference number 356, the reader device 310 may request a memory status from the memory device 340. For example, based on a completion of the handshake procedure for authentication and pairing, the reader device 310 may transmit a command to the memory device 340 requesting that the memory device 340 provide information identifying the status of the memory device 340 and a memory thereof. In some implementations, the reader device 310 may indicate a particular parameter that the memory device 340 is to provide as a response to the request for the memory status. For example, as described in more detail below, the reader device 310 may request that the memory device 340 provide information identifying a set of bad blocks generated at runtime. Additionally, or alternatively, the reader device 310 may transmit a general command for a memory status, and the memory device 340 may determine which parameters to provide to fulfill the command based on a stored configuration of the memory device 340.

In some implementations, the memory device 340 may expose one or more interfaces with which the reader device 310 can request the memory status and/or alter a configuration, as described below. For example, the memory device 340 may transmit, via an antenna module thereof, information identifying an application programming interface (API) that enables the reader device 310 to identify commands for controlling the memory of the memory device 340, obtaining memory health parameters or other memory status information, or altering memory parameters, among other examples.

As further shown in FIG. 3B, and by reference numbers 358 and 360, the memory device 340 may determine the memory status and transmit information identifying the memory status to the reader device 310. For example, the memory device 340 may determine one or more parameters relating to a memory of the memory device 340. In some implementations, the memory device 340 may communicate with the client device 330 to perform one or more operations to determine the status of the memory. For example, client device 330 may attempt a read or write operation and the memory device 340 may determine whether the read or write operation is successful. Additionally, or alternatively, the memory device 340 may determine whether any memory physical bad blocks, as described above, are generated at runtime, a memory health status, an error rate, or another memory parameter. Additionally, or alternatively, the memory device 340 may periodically determine the memory status and store the memory status to provide as a response when the reader device 310 attempts to read the memory status. For example, the reader device 310 may attempt to perform a contactless read of the memory device 340, and the memory device 340 may provide a stored memory status as output for the contactless read.

In some implementations, the memory device 340 may encode the information identifying the memory status. For example, the memory device 340 may use an encoder to encode the information identifying the memory status with encryption based on a key. In this case, the reader device 310 and/or the analysis platform 320 may use a corresponding key and/or decoder to decode the information identifying the memory status. In this way, the memory device 340 avoids inadvertent reading of the memory status by other non-authorized devices (e.g., a malicious entity).

As shown in FIG. 3C, and by reference number 362, the reader device 310 may determine a memory configuration based on the memory status. For example, the reader device 310 may determine an adjustment to one or more parameters of the memory device 340 based on the memory status. In this case, the adjustment may include deactivating or activating a memory region, switching a level of redundancy, changing a set of permissions, or the like. In some implementations, the reader device 310 may transmit the memory status to the analysis platform 320, which may transmit a response indicating the memory configuration. Additionally, or alternatively, the analysis platform 320 may log the memory status for analytics performed on a set of memory devices 340. For example, the analysis platform 320 may determine an average error rate, detect a flaw, change a manufacturing parameter, initiate a recall, or perform another automated action using the memory status of the memory device 340 and/or other memory statuses of other memory devices 340.

As further shown in FIG. 3C, and by reference numbers 364 and 366, the reader device 310 may transmit information identifying the memory configuration and the memory device 340 may apply the memory configuration. For example, the memory device 340 may receive information identifying a change to a parameter of the memory device 340, as described above, and may alter the parameter in accordance with the identified change. In some implementations, the memory device 340 may store information identifying the change to the parameter in a log, and transmit information identifying a content of the log to the reader device 310 to enable diagnostics of changes to parameters of the memory device.

As indicated above, FIGS. 3A-3C are provided as an example. Other examples may differ from what is described with regard to FIGS. 3A-3C.

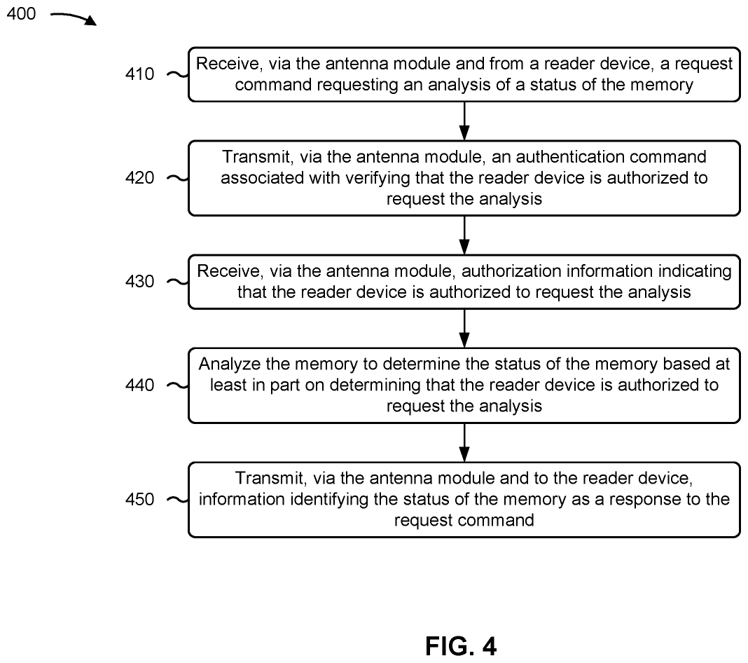

FIG. 4 is a flowchart of an example method 400 associated with contactless data transmission for memory devices. In some implementations, a system (e.g., the client device 330) may perform or may be configured to perform the method 400. In some implementations, another device or a group of devices separate from or including the system (e.g., the host device 110, the memory device 120, the memory device 340, the reader device 310, and/or the analysis platform 320) may perform or may be configured to perform the method 400. Additionally, or alternatively, one or more components of the system (e.g., the memory device 340, the memory device 120, the memory 140, the controller 130, and/or the antenna module 170) may perform or may be configured to perform the method 400. Thus, means for performing the method 400 may include the system and/or one or more components of the system. Additionally, or alternatively, a non-transitory computer-readable medium may store one or more instructions that, when executed by the system, cause the system to perform the method 400.

As shown in FIG. 4, the method 400 may include receiving, via the antenna module and from a reader device, a request command requesting an analysis of a status of the memory (block 410). As further shown in FIG. 4, the method 400 may include transmitting, via the antenna module, an authentication command associated with verifying that the reader device is authorized to request the analysis (block 420). As further shown in FIG. 4, the method 400 may include receiving, via the antenna module, authorization information indicating that the reader device is authorized to request the analysis (block 430). As further shown in FIG. 4, the method 400 may include analyzing the memory to determine the status of the memory based at least in part on determining that the reader device is authorized to request the analysis (block 440). As further shown in FIG. 4, the method 400 may include transmitting, via the antenna module and to the reader device, information identifying the status of the memory as a response to the request command (block 450).

The method 400 may include additional aspects, such as any single aspect or any combination of aspects described below and/or described in connection with one or more other methods or operations described elsewhere herein.

In a first aspect, the method 400 includes accessing the memory using the authorization information. In a second aspect, alone or in combination with the first aspect, the method 400 includes receiving, via the antenna module and based on transmitting the information identifying the status of the memory, an adjustment command identifying an adjustment to a configuration of the memory, and adjusting the configuration of the memory based on the adjustment command. In a third aspect, alone or in combination with one or more of the first and second aspects, the information identifying the status of the memory includes information identifying a set of memory health parameters.

In a fourth aspect, alone or in combination with one or more of the first through third aspects, the information identifying the status of the memory includes information identifying a set of bad blocks within the memory. In a fifth aspect, alone or in combination with one or more of the first through fourth aspects, the method 400 includes exposing, via the antenna module, a set of interfaces for use in controlling the memory by the reader device. In a sixth aspect, alone or in combination with one or more of the first through fifth aspects, the authorization information includes one or more certificates or one or more keys associated with a chain of trust of the reader device or the memory.

In a seventh aspect, alone or in combination with one or more of the first through sixth aspects, the method 400 includes an encryption engine including an encoder configured to encode the information identifying the status of the memory for decoding by a decoder of the reader device. In an eighth aspect, alone or in combination with one or more of the first through seventh aspects, the method 400 includes a secure execution environment associated with the memory and including an encoder, and a non-secure execution environment associated with the antenna module and including a decoder. In a ninth aspect, alone or in combination with one or more of the first through eighth aspects, the method 400 includes causing the encoder to encode first information regarding the memory within the secure execution environment, causing the decoder to decode the first information as second information within the non-secure execution environment, and determining the status of the memory based on the second information.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

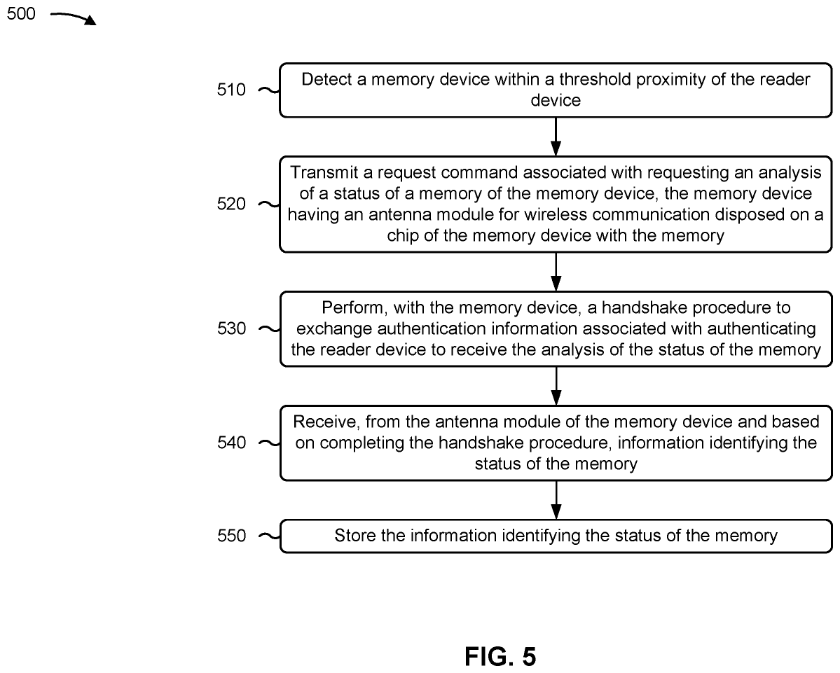

FIG. 5 is a flowchart of an example method 500 associated with contactless data transmission for memory devices. In some implementations, a reader device (e.g., the reader device 310) may perform or may be configured to perform the method 500. In some implementations, another device or a group of devices separate from or including the reader device (e.g., the host device 110, the memory device 120, the memory device 340, the client device 330, and/or the analysis platform 320) may perform or may be configured to perform the method 500. Additionally, or alternatively, one or more components of the reader device may perform or may be configured to perform the method 500. Thus, means for performing the method 500 may include the reader device and/or one or more components of the reader device. Additionally, or alternatively, a non-transitory computer-readable medium may store one or more instructions that, when executed by the reader device, cause the reader device to perform the method 500.

As shown in FIG. 5, the method 500 may include detecting a memory device within a threshold proximity of the reader device (block 510). As further shown in FIG. 5, the method 500 may include transmitting a request command associated with requesting an analysis of a status of a memory of the memory device, the memory device having an antenna module for wireless communication disposed on a chip of the memory device with the memory (block 520). As further shown in FIG. 5, the method 500 may include performing, with the memory device, a handshake procedure to exchange authentication information associated with authenticating the reader device to receive the analysis of the status of the memory (block 530). As further shown in FIG. 5, the method 500 may include receiving, from the antenna module of the memory device and based on completing the handshake procedure, information identifying the status of the memory (block 540). As further shown in FIG. 5, the method 500 may include storing the information identifying the status of the memory (block 550).

The method 500 may include additional aspects, such as any single aspect or any combination of aspects described below and/or described in connection with one or more other methods or operations described elsewhere herein.

In a first aspect, the method 500 includes encrypting the information identifying the status of the memory. In a second aspect, alone or in combination with the first aspect, a wireless connection between the reader device and the memory device is a first type of wireless connection, and the method 500 includes transmitting, via a second type of wireless connection, the information identifying the status of the memory to a client device. In a third aspect, alone or in combination with one or more of the first and second aspects, the method 500 includes determining an adjustment to a configuration of the memory device, and transmitting, for reception by the antenna module of the memory device, an adjustment command identifying the adjustment to the configuration of the memory. In a fourth aspect, alone or in combination with one or more of the first through third aspects, determining the adjustment to the configuration of the memory device comprises receiving, from a client device, information identifying the adjustment to the configuration.

In a fifth aspect, alone or in combination with one or more of the first through fourth aspects, the reader device and the memory device are configured to communicate via a near-field communication connection or radio frequency identification connection. In a sixth aspect, alone or in combination with one or more of the first through fifth aspects, the method 500 includes broadcasting an identification signal, and receiving a response to the identification signal, and detecting the memory device comprises detecting the memory device based on the response to the identification signal. In a seventh aspect, alone or in combination with one or more of the first through sixth aspects, performing the handshake procedure comprises pairing the reader device to the memory device, wherein information identifying the memory device is stored at the reader device based on pairing.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

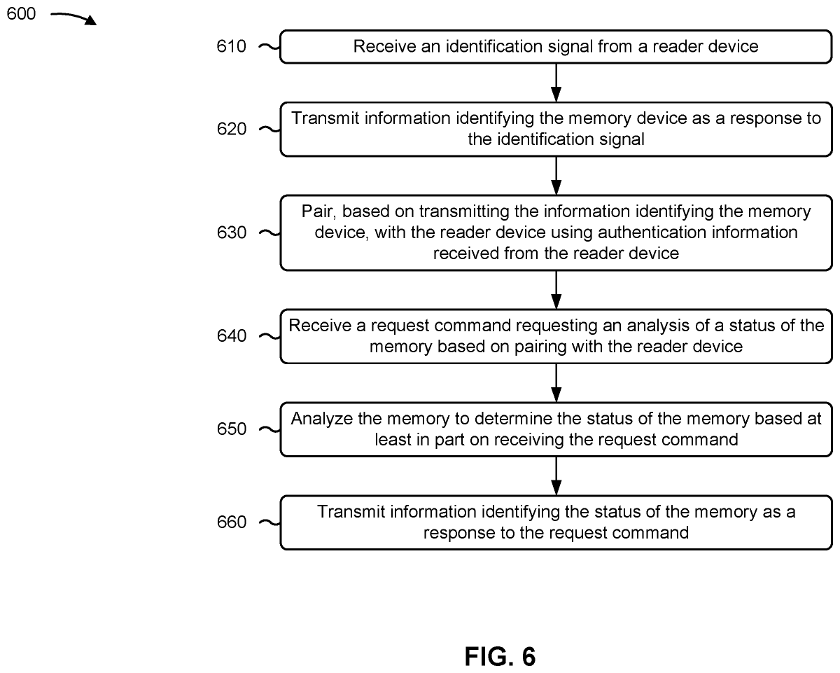

FIG. 6 is a flowchart of an example method 600 associated with contactless data transmission for memory devices. In some implementations, a memory device (e.g., the memory device 120 and/or the memory device 340) may perform or may be configured to perform the method 600. In some implementations, another device or a group of devices separate from or including the memory device (e.g., the system 100) may perform or may be configured to perform the method 600. Additionally, or alternatively, one or more components of the memory device (e.g., the controller 130, the memory management component 225, the memory 140, and/or the antenna module 170) may perform or may be configured to perform the method 600. Thus, means for performing the method 600 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 600.

As shown in FIG. 6, the method 600 may include receiving an identification signal from a reader device (block 610). As further shown in FIG. 6, the method 600 may include transmitting information identifying the memory device as a response to the identification signal (block 620). As further shown in FIG. 6, the method 600 may include pairing, based on transmitting the information identifying the memory device, with the reader device using authentication information received from the reader device (block 630). As further shown in FIG. 6, the method 600 may include receiving a request command requesting an analysis of a status of the memory based on pairing with the reader device (block 640). As further shown in FIG. 6, the method 600 may include analyzing the memory to determine the status of the memory based at least in part on receiving the request command (block 650). As further shown in FIG. 6, the method 600 may include transmitting information identifying the status of the memory as a response to the request command (block 660).

The method 600 may include additional aspects, such as any single aspect or any combination of aspects described below and/or described in connection with one or more other methods or operations described elsewhere herein.

In a first aspect, analyzing the memory comprises accessing the memory using the authentication information.

In a second aspect, alone or in combination with the first aspect, the method 600 includes receiving, via the antenna module and based on transmitting the information identifying the status of the memory, an adjustment command identifying an adjustment to a configuration of the memory, and adjusting the configuration of the memory based on the adjustment command.

In a third aspect, alone or in combination with one or more of the first and second aspects, the information identifying the status of the memory includes information identifying a set of memory health parameters.

In a fourth aspect, alone or in combination with one or more of the first through third aspects, the information identifying the status of the memory includes information identifying a set of bad blocks within the memory.

In a fifth aspect, alone or in combination with one or more of the first through fourth aspects, the method 600 includes exposing, via the antenna module, a set of interfaces for use in controlling the memory by the reader device.

In a sixth aspect, alone or in combination with one or more of the first through fifth aspects, the authentication information includes one or more certificates or one or more keys associated with a chain of trust of the reader device or the memory.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a system includes a chip; a memory disposed on the chip; an antenna module disposed on the chip and connected to the memory, the antenna module including an antenna and a transmit circuitry; and a controller configured to: receive, via the antenna module and from a reader device, a request command requesting an analysis of a status of the memory; transmit, via the antenna module, an authentication command associated with verifying that the reader device is authorized to request the analysis; receive, via the antenna module, authorization information indicating that the reader device is authorized to request the analysis; analyze the memory to determine the status of the memory based at least in part on determining that the reader device is authorized to request the analysis; and transmit, via the antenna module and to the reader device, information identifying the status of the memory as a response to the request command.

In some implementations, a method includes detecting, by a reader device, a memory device within a threshold proximity of the reader device; transmitting, by the reader device, a request command associated with requesting an analysis of a status of a memory of the memory device, the memory device having an antenna module for wireless communication disposed on a chip of the memory device with the memory; performing, by the reader device and with the memory device, a handshake procedure to exchange authentication information associated with authenticating the reader device to receive the analysis of the status of the memory; and receiving, from the antenna module of the memory device and based on completing the handshake procedure, information identifying the status of the memory; and storing the information identifying the status of the memory.

In some implementations, a memory device includes a memory disposed on a chip; an antenna module disposed on the chip and connected to the memory, the antenna module including an antenna and a transmit circuitry; and a controller configured to: receive an identification signal from a reader device; transmit information identifying the memory device as a response to the identification signal; pair, based on transmitting the information identifying the memory device, with the reader device using authentication information received from the reader device; receive a request command requesting an analysis of a status of the memory based on pairing with the reader device; analyze the memory to determine the status of the memory based at least in part on receiving the request command; and transmit information identifying the status of the memory as a response to the request command.

The foregoing disclosure provides illustration and description but is not intended to be exhaustive or to limit the implementations to the precise forms disclosed. Modifications and variations may be made in light of the above disclosure or may be acquired from practice of the implementations described herein.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system, comprising:
a chip;
a memory disposed on the chip;
an antenna module disposed on the chip and connected to the memory, the antenna module including an antenna and a transmit circuitry; and
a controller configured to:
receive, via the antenna module and from a reader device, a request command requesting an analysis of a status of the memory;
transmit, via the antenna module, an authentication command associated with verifying that the reader device is authorized to request the analysis;
receive, via the antenna module, authorization information indicating that the reader device is authorized to request the analysis;
analyze the memory to determine the status of the memory based at least in part on determining that the reader device is authorized to request the analysis; and
transmit, via the antenna module and to the reader device, information identifying the status of the memory as a response to the request command.

2. The system of claim 1, wherein the controller, when analyzing the memory, is configured to:
access the memory using the authorization information.

3. The system of claim 1, wherein the controller is configured to:
receive, via the antenna module and based on transmitting the information identifying the status of the memory, an adjustment command identifying an adjustment to a configuration of the memory; and
adjust the configuration of the memory based on the adjustment command.

4. The system of claim 1, wherein the information identifying the status of the memory includes information identifying a set of memory health parameters.

5. The system of claim 1, wherein the information identifying the status of the memory includes information identifying a set of bad blocks within the memory.

6. The system of claim 1, wherein the controller is configured to:
expose, via the antenna module, a set of interfaces for use in controlling the memory by the reader device.

7. The system of claim 1, wherein the authorization information includes one or more certificates or one or more keys associated with a chain of trust of the reader device or the memory.

8. The system of claim 1, further comprising:
an encryption engine including an encoder configured to:
encode the information identifying the status of the memory for decoding by a decoder of the reader device.

9. The system of claim 1, further comprising:
a secure execution environment associated with the memory and including an encoder; and
a non-secure execution environment associated with the antenna module and including a decoder.

10. The system of claim 9, wherein the controller is configured to:
cause the encoder to encode first information regarding the memory within the secure execution environment;
cause the decoder to decode the first information as second information within the non-secure execution environment; and
determine the status of the memory based on the second information.

11. A method, comprising:
detecting, by a reader device, a memory device within a threshold proximity of the reader device;
transmitting, by the reader device, a request command associated with requesting an analysis of a status of a memory of the memory device, the memory device having an antenna module for wireless communication disposed on a chip of the memory device with the memory;
performing, by the reader device and with the memory device, a handshake procedure to exchange authentication information associated with authenticating the reader device to receive the analysis of the status of the memory; and
receiving, from the antenna module of the memory device and based on completing the handshake procedure, information identifying the status of the memory;
and storing the information identifying the status of the memory.

12. The method of claim 11, further comprising:
encrypting the information identifying the status of the memory.

13. The method of claim 11, wherein a wireless connection between the reader device and the memory device is a first type of wireless connection; and
further comprising:
transmitting, via a second type of wireless connection, the information identifying the status of the memory to a client device.

14. The method of claim 11, further comprising:
determining an adjustment to a configuration of the memory device; and
transmitting, for reception by the antenna module of the memory device, an adjustment command identifying the adjustment to the configuration of the memory.

15. The method of claim 14, wherein determining the adjustment to the configuration of the memory device comprises:
receiving, from a client device, information identifying the adjustment to the configuration.

16. The method of claim 11, wherein the reader device and the memory device are configured to communicate via a near-field communication connection or radio frequency identification connection.

17. The method of claim 11, further comprising:
broadcasting an identification signal; and
receiving a response to the identification signal; and
wherein detecting the memory device comprises:
detecting the memory device based on the response to the identification signal.

18. The method of claim 11, wherein performing the handshake procedure comprises:
pairing the reader device to the memory device, wherein information identifying the memory device is stored at the reader device based on pairing.

19. A memory device, comprising:
a memory disposed on a chip;
an antenna module disposed on the chip and connected to the memory, the antenna module including an antenna and a transmit circuitry; and
a controller configured to:
receive an identification signal from a reader device;
transmit information identifying the memory device as a response to the identification signal;
pair, based on transmitting the information identifying the memory device, with the reader device using authentication information received from the reader device;
receive a request command requesting an analysis of a status of the memory based on pairing with the reader device;
analyze the memory to determine the status of the memory based at least in part on receiving the request command; and
transmit information identifying the status of the memory as a response to the request command.

20. The memory device of claim 19, wherein analyzing the memory comprises:
accessing the memory using the authentication information.

21. The memory device of claim 19, wherein the controller is configured to:
receive, via the antenna module and based on transmitting the information identifying the status of the memory, an adjustment command identifying an adjustment to a configuration of the memory; and
adjust the configuration of the memory based on the adjustment command.

22. The memory device of claim 19, wherein the information identifying the status of the memory includes information identifying a set of memory health parameters.

23. The memory device of claim 19, wherein the information identifying the status of the memory includes information identifying a set of bad blocks within the memory.

24. The memory device of claim 19, wherein the controller is configured to:
expose, via the antenna module, a set of interfaces for use in controlling the memory by the reader device.

25. The memory device of claim 19, wherein the authentication information includes one or more certificates or one or more keys associated with a chain of trust of the reader device or the memory.
